(19) United States
(12) Patent Application Publication
(10) Pub. No.: US 2005/0114173 A1
(43) Pub. Date: May 26, 2005

(54) Market driven health care system

(76) Inventor: Terry L. Harris, Inola, OK (US)

Correspondence Address: Robert E. Massa, Ste 102, 1535 South Memorial, Tulsa, OK, 74112-7046, US

(21) Appl. No.: 10/719,459

(22) Filed: Nov. 21, 2003

(51) Int. Cl. G06F 17/60

(52) U.S. Cl. 705/2

(57) ABSTRACT

A health care system in which the operator of the health care service establishes access means to and for a consumer who is seeking health care service, access means to and for medical providers for the description of their services, access means to and for hospital providers, and access means to and for insurance companies. The operator of the heath care service accumulates data in suitable report form to transmit to a consumer to enable the consumer to choose a provider of his favor and contact directly with each chosen provider to determine the health services he wishes in conjunction with an insurance premium rate for those services. This system is intended to accumulate reference material for an interested consumer who is then able to develop his own medical coverage for a chosen insurance premium, or “indemnity product”. Neither the medical provider, nor hospital provider, nor insurance provider become infinitely entangled with another code system generated for their mutual use, because this health care service system is a referral system and does not require the maintenance of mutual records. The consumer chooses, negotiates, and makes his own choices.

### FIELD OF THE INVENTION

My invention relates to health care services. More particularly, my invention relates to a system for obtaining descriptions of medical services from various medical providers in order to place suitable medical providers in communication with a consumer who is seeking health care services. More particularly, my invention relates to a system for establishing a health care service in which an information media provides means for placing a consumer, who is in search of certain health care services, in direct communication with a suitable medical provider, suitable hospital provider, and insurance carrier, in order for the consumer to negotiate a proper degree of insurance coverage which would be proper for the medical services and hospital services, and ancillary services which the consumer wishes to have.

### BACKGROUND OF THE INVENTION

In the United States the inflationary trend for most goods and services has been less than 5% per year for the last decade. But, for the same decade, the inflationary trend for health care has been between 10%-15% per year for that same decade.

A significant reason for the difference between these trends is that health care delivery is not market driven. Consumers understand the cost of health care insurance, but have no understanding of the cost of health services.

The health insurance industry apparently has no real control over health care cost or the premiums would not be increasing at a rate that is three to six times as high than the rest of the economy. In fact, the insurance industry basically services as a bank through which deposits are, in the manner of premiums, and payments are issued as claims. Although there have been attempts made by the insurance industry to develop various programs, such as HMO's and PPO's, that tend to stabilize rising premium costs, those programs have failed because they are negotiated between the insurance companies and the providers of the various medical care. Those programs have failed because, in all such negotiations, profit without risk is the sole motivation of both parties. Insurance companies serve a useful purpose as the administrative and logistical liaison of the heath care industry. The cost associated with that function is about 15% of the health care premium dollar. However, their role should not extend to the negotiation of health care costs with the medical providers in behalf of consumers.

Increasing, the provider of various care is in fact a hospital or conglomerate of hospitals who negotiate in behalf of the physicians and ancillary providers who are under contract to a hospital entity. Management of these organization negotiates from a position of strength since, in most cases, they collectively represent the major segment of health care delivery in a given market. Insurance companies are forced to accept the pricing presented by hospitals in order to successfully market their products. The results of these closed negotiations are passed on to the consumer via premium increases. The result is a closed, monopolistic market.

Ironically, the consumer, who is the end user of the health care delivery system, has no say in these price negotiations, since realistically, there are no alternatives to the insurance products available to him. It is obvious that the hospital conglomerates do not have an incentive or desire to move to a market driven system. In fact, if left unchecked, the medical system will evolve to a monopoly within 10 years.

As I have noted, and stated therein, consumers have, until recently, demanded more and more benefits from their health insurance plans. Services that were uniformly excluded from insurance polices 20 years ago are now be covered in services as a result of demands by consumers on the state and federal legislatures to enact expanded benefits.

As a result, the insurance industry has responded with the concept of “managed care”. I have discussed the financial negotiations conducted between insurance companies and medical providers. The effectiveness of that part of managed care has been minimal, demonstrated by the extraordinary premium increases from year to year. However, the second part of the “managed care” concept has dealt with a level of care and the necessity of care received by the insureds and the insurance industry's attempt to monitor these factors for the purpose of saving money.

After numerous laws were enacted which were intended to favor the consumers, the insurance industry had little or no authority to underwrite the potential risks associated with any employer health care group. Thus, without authority to reject or limit the benefits for specific high risk individuals within a group of insured members, the insurance companies then attempted to limit to cost of delivering health care to the insured members by monitoring when, where, why, and how that care was delivered.

Consumers were not satisfied with these restrains either, and have now successfully lobbied for relief from this type of third party intervention concerning health care decisions. Legislation that is intended to be enacted over the next 12 months, will severely restrict managed care organizations from altering or challenging a plan of treatment prescribed by a physician.

While I agree with these anticipated regulations, I realize, as do the members of the insurance industry, that the price of health care and health insurance premiums will increase at a higher level and faster rate than even current projections have made as a result of these laws.

It is ironic that the same consumer who demanded few restrictions with less monitoring, will soon realize the added burden of higher premiums. However, it is this vivid realization that will be the catalyst for a market driven system. The basic laws of economics are always present.

The consumer has been restricts in the past from having any choice in the price side of health care service. If the consumer is not given the opportunity to become involved in the determination of cost of the health care services, then, ultimately, the government will intervene to ration care and mandate pricing. My proposal, that I describe herein, is to provide a system in which the consumers have the choice of determining market price.

Knowing the comparative price for a product or service is important, but, to be meaningful, the consumer should know what he will be receiving for that price. In my system, the consumer is given an option to choose a service or product he wishes. Current systems do not provide ample choice for a consumer as to his individual needs, geography, religious choice, family needs, or suitable travel needs.

An insurance company engaged in the plan must develop a base benefit package that relates to the prices established by the various providers. The base set of benefits provided by an insurer should be designed to pay the total amount of a claim if the providers charge is at or less than the stated benefit. Consumers should be given the opportunity to pay higher premiums for higher levels of coverage based on their informed decision to seek care from providers who charge higher prices.

The Internet can be adapted as a means for communicating with consumers and providers. Medical and hospital providers can establish their pricing schedules on the Internet and constantly maintain their schedules. This information will be accessible to all parties in the health care service group. My system is to place consumers in communication with a number of providers for that consumer to make a responsible choice.

In accordance with the usual procedure, I conducted a patent search which revealed the following references of patent and patent application publication material which were considered to be the closest to my invention:

| | | |
|---|---|---|
| U.S. Pat. No. 6,014,629 | DeBrain-Ashton | Jan. 11, 2000 |
| Pub. No. US 2001/0034613 A1 | Rubsamen | Oct. 25, 2001 |
| Pub. No. US 2002/0065759 A1 | Henley | May 30, 2002 |
| Pub. No. US 2002/0069085 A1 | Engel et al | Jan. 6, 2002 |
| Pub. No.. US 2002/0082866 | Ladouceur et Al | Jun. 27, 2002 |
| Pub. No. US 2002/0120554 A1 | Vega | Aug. 29, 2002 |
| Pub. No. US 2002/0178030 A1 | Loeb | Nov. 28, 2002 |
| Pub. No. US 2003/0009355 A1 | Gupta | Jan. 9, 2003 |
| Pub. No. US 2003/0028442 A1 | Wagstaff et al | Feb. 16, 2003 |
| Pub. No. US 2003/0046169 Al | Fraser at al | Mar. 6, 2003 |
| Pub. No. US 2003/0060688 A1 | Ciarnello et al | Mar. 27, 2003 |
| Pub. No. US 2003/0120513 A1 | Samaquial | Jun. 26, 2003 |
| Pub. No. US 2003/0154104 A1 | Koningsberg | Aug. 14, 2003 |
| Pub. No. US 2003/0154103 A1 | Koningsberg | Aug. 14, 2003 |

DeBruin-Ashton describes a computerized system for compiling a directory of physicians for a health care provider in which the directory is tailored to a particular customer of the service.

Rubsamen describes a computerized system for obtaining, analyzing, and providing details of a patient'prescribed medications by providing user access to a community of patients.

Henley describes a computerized system in which a transaction system server handles online communications and procedures for conducting auctions for various services, and maintains a registration database of service providers and bidders.

Engel describes a method of selling health care services to a patient, in which system a health care operator establishes contracts with service provides and stores pertinent information in a database. A prospective patient is assisted in generating a case statement. The service operator is made available to contracting health care providers. Interested medical providers respond to the system operator with their proposals and the operator then delivers these to a prospective patient.

Ladouceurr et al describes a method for integrated management of medical products and medical procedures. The user conducts a product search, a procedure search, or a venture search to obtain information about medical products stored therein.

Vega described a computer-implemented system which provide a site accessible to various service providers and purchasers of services. The computer-implemented system includes lholographic imagery for the users. Upon receiving a request from a purchaser, the system automatically determines whether a stored description of services corresponds to the requested service.

Loeb describes a computerized system made available to a wide access communication network made answerable to a inquiry pertaining to a medical condition of concern to the user, and providing information on treatment options for a medicall condition.

Gupta describes a system for management of a health care services which combines new financial structure for health insurance and health benefit plans, payment methods, and related procedures.

Wagstaff describes a medical screening service which includes furnishing a medical recording device to a customer, arranging for the customer to adapt said medical recording device to transmit medical information to the screening center, and making an assessment report directly to the consumer.

Fraser et al describes a computer-implemented system for procuring and managing professional services including prompting a service provides to complete an online service order which identifies an estimated time of delivery, estimated cost of the service and the predicted results. The customer stores the estimates in a computer memory. The service provider completes a completion order for comparison to the original service order.

Ciarnello et al describes a management system for an early warning system for high risk individuals, which compares an mdovodial's current medical condition to records of the individual's clinical information, and provides data processing for that information.

Samaquial describes a method of facilitating access to health-related information to a user with a remote health care practitioner over a network.

Koningsberg 4103 and 4104 both describe methods of operating health care service savings plans without requiring a monthly fee.

### OBJECTS AND ADVANTAGES OF MY INVENTION

The primary object of my invention is to provide a health care service system which is simple to organize and efficient to manage.

Another object of my invention is to provide a health care service system which provides efficient operation by elimination of many of the time-consuming conditions prevailing in health care service systems today.

Still another object of my invention is to provide an efficiently operable health care system in which an operator of the service is knowledgeable on medical issues and insurance issues and is able to provide proper recommendations to an inquiring party.

Then, the above objects and advantages of my invention will become apparent from my description of the following embodiments of my invention.

### BRIEF DESCRIPTIONS OF THE DRAWINGS

FIG. 1 is a generalized outline of a health care service system as the basic steps would be expressed.

FIG. 2 is a generalized outline of a typical chart of medical charges as they would appear on a health care service plan today.

FIG. 3 is a generalized outline of a typical chart of hospital charges as they would appear on a health care service plan today.

### SUMMARY OF MY INVENTION

The element needed to change health care service from a monopolistic system to an open market driven system is for the consumer to have proper knowledge of all service prices of all providers. Knowledgeable purchasing decisions are made by consumers daily for every product or service they want. In almost every field, the selling prices for those commodities are clearly accessible. In some cases, price might not be the determining factor for making a purchase, but it is always a known factor before a purchase is made. The price for an item is known, except when health care service before the commodity. In fact, the price of health care services is actually a known factor before the health care service is received, but it is not disclosed to the consumer until after the consummation.

My invention describes a system for providing a consumer with suitable and sufficient ability to be given a choice to have reasonable market control.

My system provides for the consumer to have direct negotiating power with all medical providers, hospital providers, insurance companies, and any ancillary providers of any nature, in order to obtain health care service protection of his own choice.

The consumer, a person or group which has been seeking heat care services, is placed in contact, for a fee, with medical providers, hospital providers, and insurance companies.

The operator of my health care service system may either recommend a medical provider to a prospective consumer from records already on file in the operator's office from medical providers which made their services available by means of the Internet, or the operator may provide a concerted effort to find a medical provider of a unique capability according to a consumer's needs.

In like manner, the operator may either be able to recommend hospital service from Internet records or act according to a consumer's wishes.

A market driven system must always have a point of reference component in order for pricing to be successful. That is, price by itself has little meaning unless a person can relate one price to another for the same or similar product or service.

For example, concerning medical providers, the Medicare program has established a fee schedule for all procedures as performed by physicians. Therefore, this is a point of reference.

For hospital care, a common method of pricing hospital patient services is a per diem fee. For each day that a patient is in a hospital, a fixed amount is charged to the health care service. Also, hospitals often charge a fixed price for outpatient care for a particular procedure, such as an appendectomy.

Some of the systems described by the above references would be considered systems that are more “executory” then “administrative”. This means that they are providing more legal authority to the agent handling the system than would be wise.

After analyzing the many difficulties and frailties in today's health care service systems, I developed a market driven health care service system which I describe herein.

### DETAILED DESCRIPTION OF MY INVENTION

The basis of my invention is developing a computerized data gathering system in a manner to provide a simplified health care service system. The system comprises data compiled from pertinent customers and medical and insurance providers to be accessible to a customer in a manner to set up initial and direct contact and negotiation.

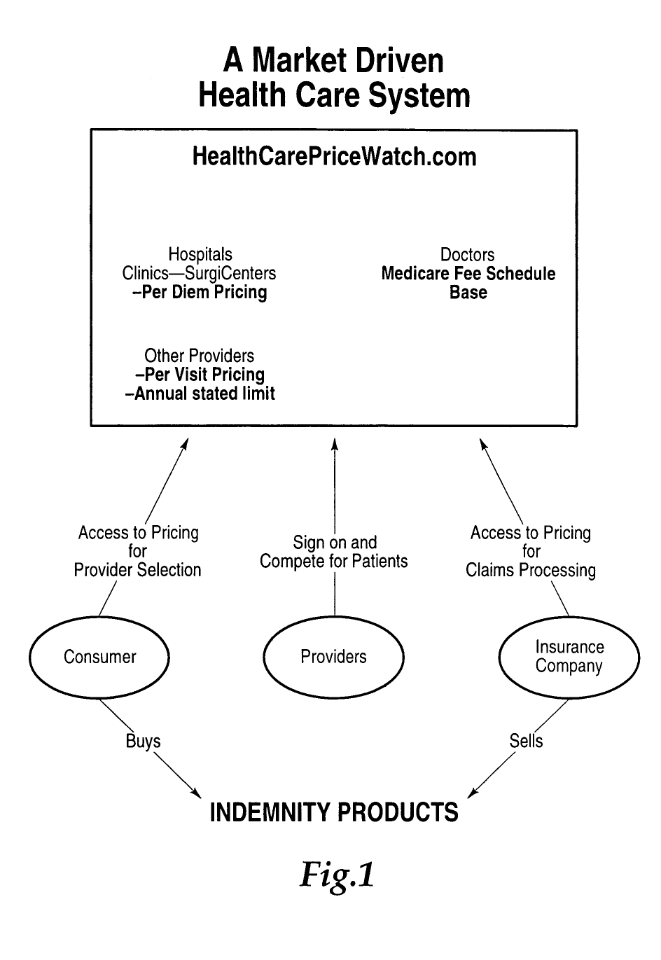

FIG. 1, I presented a scheme outlining in correlation form, the typical steps for the operators, consumers, and providers of my system.

For example, at the organization of a new system in accordance with this invention, it would be necessary and expected that the initial phase of operation would be for the operator of the system to properly organize a suitable computer system and make arrangements to place that system in suitable contact with Internet or a similar media to perform in the manner of the Information Media.

Then, a normal second step is a matter of being in by or to a prospective consumer, someone anxious to find proper health care service providers. At this stage, the consumer does not have a clear idea of what kind and amount of medical, hospital, and insurance coverage he might need or be able to find. The operator makes his service clearly accessible.

The initial work for the operator is to find a suitable medical, hospital provider, and insurance provider for establishment of a suitable record file.

Upon accumulation of sufficient data from medical providers and hospital providers, the operator secures an initial commitment from a consumer, then provides the consumer with suitable records disclosing the medical providers and hospital providers for the consumer to digest and choose.

Then, by being given information accumulated from the various providers, in the form of their various fee schedules, the consumer is placed into direct negotiating position with the various providers and forms the contract coverage he wants.

The various insurance companies who would be initially committed, or would eventually become committed thereto, would have access and knowledge of the costs and pricing schedules of all the medical providers, hospital providers, and any ancillary providers enlisted in the system, and have developed their own “indemnity products” for the numerous services established by the other providers. An “indemnity product” clearly and completely relates in detail to all the prices established by any and all of the other providers.

In my system, the consumer chooses the “indemnity product” he prefers, then submits a deposit to the operator of the system for a reference by the operator, then completes a contract with the providers.

By being given the references to suitable insurance carriers, the consumer is placed in position to negotiate with the insurance companies of his choice.

The consumer is given the option of choosing a provider or group of providers, which choice might be influenced by other factors, such as geography, accessibility, reputation of the providers, or innate philosophy of the consumer.

After locating providers which are apparently suitable to what the consumer wants, the operator places the consumer in direct contact with those providers to begin his own negotiation.

After adequate deployment of the system, of course, it is to be assumed that the operator will have considerable medical, hospital, and insurance records which are expected to be available for further development.

An operator of a health care service system according to my invention is essentially bringing parties together, a consumer and a provider, with no involvement in negotiating a price or any other terms of the transactions, unlike a broker, whose duty is to bring the parties to an agreement according to the terms for which the broker was hired.

The system I have described therein is made most conveniently and efficiently by computer implementation, and particularly, by use of the Internet.

Our Internet experiences shorten the job of teaching consumers how to shop on the WEB. I am proposing a media campaign designed to educate the public about real patient rights, the right to select the provider of their choice with full knowledge of the payment amount allowed by the carrier and the payment amount acceptable by the provider, especially those amounts which are known before services are rendered.

I have described direct negotiation and provide this in my system. Physicians have been and will continue to be the first factor considered by consumers when making decisions about health care. The WEB approach must offer physicians a convenient method of participation and allow them to submit profile information that separates and personalizes them in their respective specialties.

As with any new program, the numbers of participating physicians will increase as the public demands more access. The unique aspect of the WEB approach is that physicians and another providers can agree to participate at the pricing level of their choice. Historically, the PPO's and HMO's have required discounts from physicians as a condition of participation. The WEB approach allows the physician to advertise to the consumer both his qualifications and his price. The market will tell each physician or other provider what he might find available.

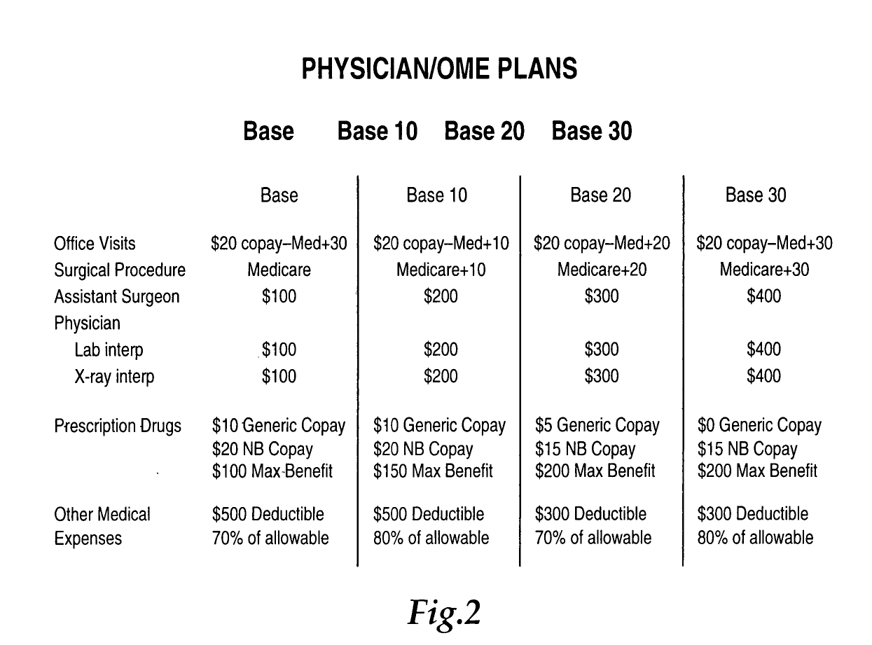

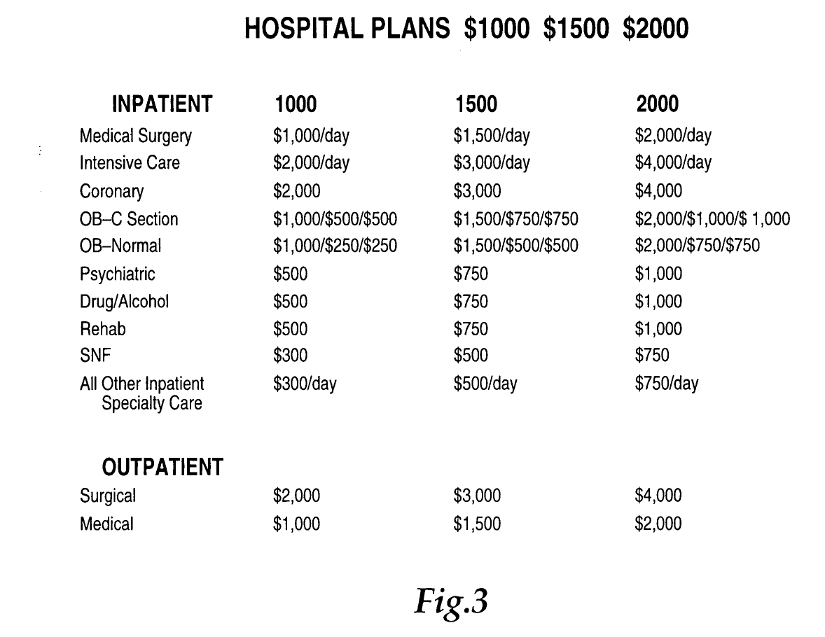

The largest piece of health care cost is the hospital. A hospital is reluctant to disclose its pricing in an understandable format. However, hospitals that need to increase their market share will be quick to advertise their competitiveness. Along with hospitals seeking a higher market share, outpatient clinics and surgicenters offer a cost effective alternative to hospital settings. These clinics and surgicenters will participate on the WEB and will place considerable pressure on all hospitals to offer competitive pricing. Ancillary providers, such as home health, hospice, laboratories, physical therapy providers, chiropractors, psychiatrists, psychologists, and other will readily compete on the WEB. In FIGS. 2 and 3 I show typical fee schedules which are similar to today's means.

With the WEB information in place and growing and with the right consumer education, the timing will be right for a carrier to introduce a set of indemnity products to the public. With minimal investment of time and dollars, a carrier can market products that cater to the patient need and capability to make informed decisions about health care. The format of an indemnity product is relatively simply. Benefits are grouped by the type of service and are limited to major procedures that account for the bulk of care received by patients.

In my system, a participating provider will be able to establish the level he will accept for undefined procedures. Once the carrier introduces indemnity products to match the WEB network, then all pricing information and benefit payment information is available to all parties.

Since many different embodiments of my invention may be made without departing from the spirit and scope thereof, it is to be understood that the specific embodiments described in detail herein are not to be taken in a limiting sense, since the scope of my invention is best defined by the appended claims.

1. A system for establishing health care services comprising the steps of:
accessing a consumer to describe option-based health care services,
accessing a medical service provider to obtain a schedule of available medical services,
accessing a hospital to obtain a schedule of available hospital services,
accessing a insurance company to obtain a schedule of available insurance services,
providing a consumer with a schedule of available medical services and a schedule of available hospital services.

2. A system for establishing health care services according to claim 1, further comprising:
preparing a medical services fee schedule in report form for a consumer and an insurance company,
preparing a hospital services fee schedule in report form for a consumer and an insurance company.

3. A system for establishing health care services according to claim 2, further comprising:
preparing an insurance company rate schedule in report form for a consumer.

4. A system for establishing health care services according to claim 3, further comprising:
determining a fee schedule of medical services fees and hospital services fees according to the option of the consumer and acceptable to an insurance company, and
determining a fee from an insurance company rate schedule according to the option of the consumer and acceptable to an insurance company, said fee to be described as an indemnity product.

5. A system for establishing health care services according to claim 4, further comprising:
establishing a line of communication between a consumer and an insurance company for said indemnity product.

6. A system as described in claim, wherein said system further comprises:
an information media providing means for:
accessing a consumer,
accessing a medical services provider,
accessing a hospital, and
establishing a line of communication between a consumer and an insurance company for communicating an indemnity product.

7. A system as described in claim 2, wherein said system further comprises:
an information media providing means for establishing a line of communication between a consumer and in insurance company for communicating said indemnity product.

8. A system as described in claim 3, wherein said system further comprises:
an information media providing means for establishing a line of communication between a consumer and an insurance company for communicating said indemnity product.

9. A system as described in claim 4, wherein said system further comprises:
an information media providing means for establishing a line of communication between a consumer and an insurance company for communicating said indemnity product.

10. A system as described in claim 5, wherein said system further comprises:
an information media providing means for establishing a line of communication between a consumer and an infurance company for communicating said indemnity product.
